(19) United States
(12) Patent Application Publication
(10) Pub. No.: US 2026/0044000 A1
(43) Pub. Date: Feb. 12, 2026

(54) WORKING-RANGE EXTENDING PHASE PLATE, ASSOCIATED IMAGING SYSTEM, AND METHOD

(71) Applicant: Cognex Corporation, Natick, MA (US)

(72) Inventors: John Filhaber, Norwich, CT (US); Jia Yang, Franklin, MA (US); José Fernández Dorado, Vaals (NL)

(21) Appl. No.: 19/295,243

(22) Filed: Aug. 8, 2025

Related U.S. Application Data
(60) Provisional application No. 63/681,619, filed on Aug. 9, 2024.

(51) Int. Cl. G02B 27/00; G02B 5/00; G02B 5/30

(52) U.S. Cl. CPC G02B 27/0075; G02B 5/001; G02B 5/3083

(57) ABSTRACT

A working-range-extending phase plate includes a central region, an inner annular region surrounding the central region, and an outer annular region surrounding the central region and the inner annular region. The central region has a central phase-transmission function. The inner annular region has an inner phase-transmission function. The outer annular region has an outer phase-transmission function. Respective magnitudes of the central, the inner, and the outer phase-transmission functions are, as a function of radial distance from an optical axis of the phase plate, one of: (i) constant, increasing, and increasing, (ii) decreasing, constant, and increasing, or (iii) decreasing, decreasing, and constant.

### CROSS-REFERENCE TO RELATED APPLICATIONS

The present application claims priority to U.S. Provisional Patent Application No. 63/681,619 filed on Aug. 9, 2024, the entire content of which is incorporated herein by reference for all purposes.

### BACKGROUND

Vision systems that perform measurement, inspection, alignment of objects and/or decoding of symbology in the form of machine-readable symbols (also termed “IDs,” such as a 2D matrix symbol) are used in a wide range of applications and industries. These systems are based around the use of an image sensor, which acquires images (typically grayscale or color, and in one, two, or three dimensions) of the subject or object, and processes these acquired images using an on-board or interconnected vision system processor. The processor generally includes both processing hardware and non-transitory computer-readable program instructions that perform one or more vision system processes to generate a desired output based upon the image's processed information. This image information is typically provided within an array of image pixels, each having various colors and/or intensities. In the example of a symbol reader (also termed herein, an “imaging device”), the user or automated process acquires an image of an object that is believed to contain one or more symbols. The image is processed to identify symbol features, which are then decoded by a decoding process and/or processor to obtain the inherent alphanumeric data represented by the symbol.

In operation, a symbol reader typically functions to illuminate the scene containing one or more symbols. The illuminated scene is then acquired by an image sensor within the imaging system. The image sensor pixels are exposed, and the electronic value(s) generated for each pixel by the exposure is/are stored in an array of memory cells that can be termed the “image” of the scene. In the context of a symbol-reading application, the scene includes an object of interest that has one or more symbols of appropriate dimensions and type. Accordingly, the symbol(s) are part of the stored image.

A common use for symbol readers in manufacturing and logistics settings is to track and sort objects in motion (e.g., via a conveyor, robotic arm, or other transport device). The symbol reader, or more typically, a plurality (constellation) of readers, can be positioned about a viewing area or volume at an appropriate viewing angle(s) to acquire images of any expected symbols on the face(s) of respective objects as they each move through the field of view of the reader. Generally, the focal distance of the symbol reader with respect to the object can vary, depending on the placement of the reader with respect to the location and the size of the object.

Typical symbol readers operate to acquire 2D images of the objects, where the symbol on each object may vary in location (e.g., due to variance in object height). Hence, a vertical distance between the symbol and the symbol reader varies within a range. Most symbol readers have a fixed-focus lens. Such a lens has a limited range, herein referred to as a working range, wherein the lens enables production of an image of a symbol of sufficient contrast (i.e., able to be read or decoded accurately).

A common way of improving the working range is “stopping down,” or reducing the aperture size of the lens. It is well known that this increases depth-of-field and hence also the lens's working range. However, the immediate penalty of reducing the aperture size is a loss of image intensity. This penalty becomes less acceptable as exposure times decrease to limit blur (e.g., when objects are traveling at higher speeds), and also as image-sensor pixel counts increase.

A second method of increasing working range is to increase object distance—the distance between the imaging device and the tracked objects—as depth-of-field increases with distance. A drawback of this approach is decreased intensity, one or more of (a) longer distances that must be kept clear of obstructions and (b) intermediate beam folding optics required to package the imaging system.

### SUMMARY OF THE EMBODIMENTS

Embodiments disclosed herein enable fixed-focused vision systems with extended working range while avoiding the aforementioned problems with existing solutions.

In a first aspect, a method for extending a working range of an imaging system is disclosed. The imaging system has an optical axis and an aperture stop. The method includes at least one of: (i) adding a first phase delay to a central region of the aperture stop; (ii) adding a second phase delay to an inner annular region, of the aperture stop, that surrounds the central region; or (iii) adding a third phase delay to an outer annular region, of the aperture stop, that surrounds the central region and the inner annular region. Magnitudes of the first, the second, and the third phase delay are, respectively a first function, a second function, and a third function of radial distance from the optical axis.

In a second aspect, a working-range-extending phase plate is disclosed. The working-range-extending phase plate includes a central region, an inner annular region surrounding the central region, and an outer annular region surrounding the central region and the inner annular region. The central region has a central phase-transmission function. The inner annular region has an inner phase-transmission function. The outer annular region has an outer phase-transmission function. Respective magnitudes of the central, the inner, and the outer phase-transmission functions are, as a function of radial distance from an optical axis of the phase plate, one of: (i) constant, increasing, and increasing, (ii) decreasing, constant, and increasing, or (iii) decreasing, decreasing, and constant.

### BRIEF DESCRIPTION OF THE FIGURES

FIG. 1 is a diagram showing a vision system that includes an imaging device, in an embodiment.

FIG. 2 is a schematic of an example extending working-range imaging system included in embodiments of an imaging device of FIG. 1.

FIGS. 3 and 4 are, respectively, a cross-sectional view and a plan view of a phase plate, which is an example of a phase plate of the imaging system of FIG. 2, in embodiments.

FIG. 5 is a graph of an even-aspheric surface sag, which is a surface sag of a surface of an embodiment of the phase plate of FIG. 3.

FIG. 6 is a graph of an odd-aspheric surface sag, which is a surface sag of a surface of an embodiment of the phase plate of FIG. 3.

FIG. 7 is a schematic of imaging systems that are embodiments of the imaging system of FIG. 2.

FIG. 8 is a plan view of a spectral filter, which is an example of a spectral filter of embodiments of the imaging system of FIG. 2.

FIG. 9 is a side view of an embodiment of the spectral filter of FIG. 8 aligned to an embodiment of the phase plate of FIG. 3.

FIG. 10 is a flowchart illustrating a method for extending a working range of an imaging system, in an embodiment.

### DETAILED DESCRIPTION OF THE EMBODIMENTS

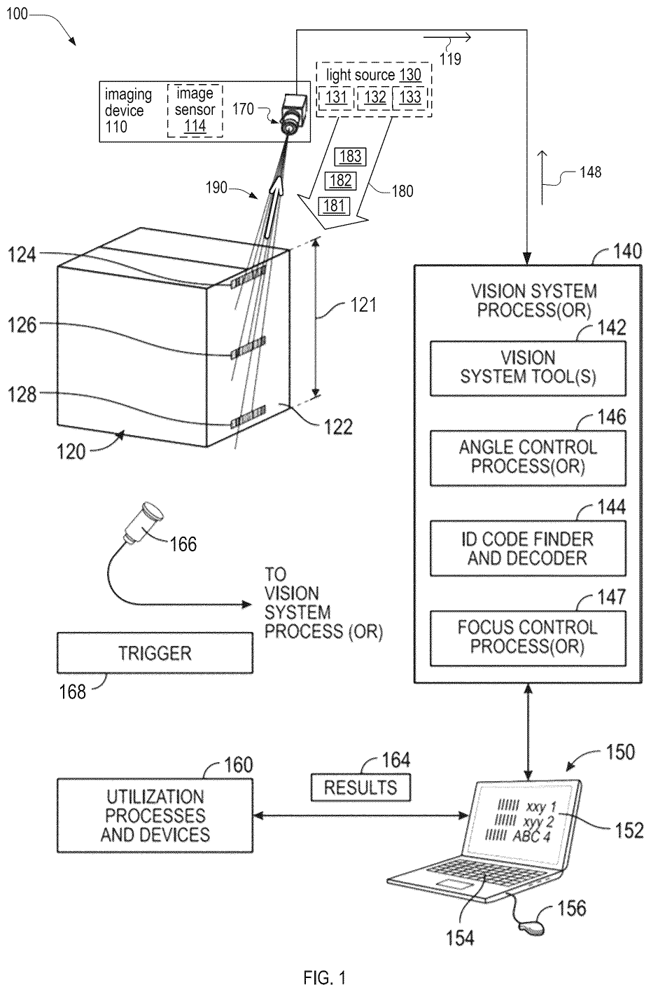

FIG. 1 shows a vision system 100 for use in providing an enhanced depth of field useful in imaging detailed features, such as symbols, located on imaged object surfaces over a relatively large distance. Vision system 100 includes an imaging device 110, which has an imaging system 170. Vision system 100 may also include at least one of a light source 130 and a vision system processor 140.

Light source 130 emits illumination 180 toward a target 120. Illumination 180 includes at least one of spectral bands 181, 182, and 183, which may correspond to red, green, and blue regions of the electromagnetic spectrum, respectively. Light source 130 may be configured to emit illumination 180 such that at any given time, illumination 180 includes one or more spectral bands 181-183.

In embodiments, light source 130 may include independently controllable emitters 131, 132, and 133, which emit light having respective spectral bands 181, 182, and 183. Light source 130 may include an RGB LED. Spectral bands 181, 182, and 183 may correspond to blue, green, and red spectral bands of the electromagnetic spectrum, respectively. Example wavelength ranges of the blue, green, and red passbands are, respectively, 440-490 nm, 490-570 nm, and 620-780 nm. Light source 130 may be communicatively coupled to vision system processor 140, which may independently control one or more of emitters 131-133.

Target 120 reflects illumination 180 as reflected illumination 190, which includes at least one of spectral bands 181, 182, or 183. Imaging system 170 directs reflected illumination 190 to a sensor of imaging system 170. Target 120 may be a box, as shown in FIG. 1. Light source 130 may be part of imaging device 110. In embodiments, each of illumination 180 and reflected illumination 190 has an optical spectrum that includes wavelengths in at least two of the blue, the green, and the red regions of the electromagnetic spectrum.

In example mode of operation, imaging device 110 acquires an image of a side 122 of target 120, and vision system 100 acquires and decodes symbols 124, 126, and 128 on side 122. Symbols 124, 126, and 128 are at different locations along a height 121 of target 120. The variation in height, in combination with the small and precise details present in the symbols, can make the task of decoding somewhat challenging. That is, an imaging system with a conventional depth of field and working range may only be able to focus adequately upon one or two symbols, but not all three symbols. Changing focus and acquiring more than one image in a single scene can allow symbols at differing distances to be acquired. However, this approach can also be disadvantageous where objects are moving quickly (e.g., via a conveyor in a logistics situation), where rapid imaging is desired.

Imaging device 110 may include an image sensor 114, which may be communicatively coupled with vision system processor 140. Image sensor 114 may be part of imaging system 170. A pixel array of image sensor 114 may be color or grayscale, and may be either one-dimensional or two-dimensional. Image sensor 114 may be a monochromatic image sensor. For example, image sensor 114 may lack a color filter array.

Image data 119 is transmitted to processor 140 from imaging device 110. Processor 140 may be contained completely or partially within the housing of imaging device 110. Processor 140 carries out various vision system processes using image data transmitted from image sensor 114. Processor 140 may include, but is not limited to, vison tools 142, such as edge detectors, segmenting tools, blob analyzers, caliper tools, pattern recognition tools, and other useful modules. Processor 140 may also include a symbol finder and decoder 144, according to a conventional or custom arrangement. Data from vision system tools determines whether symbol candidates are present in the analyzed image(s). The symbol decoder function may then employ conventional functional modules, as well as custom processors/processes, to decode found symbol candidates within the image.

Other processes and/or modules may provide various control functions—for example, auto-focus, illumination, image acquisition triggering, etc. Appropriate control data/signals 148 may be transmitted from processor 146 to a drive mechanism of imaging system 170. Processor 140 may include a focus control processor 147, which provides focus information to a variable (e.g., liquid) lens assembly of optics.

Alternatively, some or all of processor 140 may be contained within a general purpose computing device 150, such as a PC, server, laptop, tablet, or handheld device (e.g., smartphone), which can include a display and/or touchscreen 152 and/or other forms of conventional or custom user interface, such as a keyboard 154, mouse 156, etc. It should be clear that a variety of processor arrangements and implementations can be employed to provide vision system functionality to vision system 100 in alternate embodiments. Similarly, when vision system 100 is used for tasks other than symbol decoding, appropriate vision system process modules may be employed—for example, where the vision system is used for inspection, a training process module and trained pattern data can be provided.

Computing device 150 and/or processor 140 is shown linked to one or more data utilization processes and/or devices 160. Results 164 from symbol-decoding and/or other vision system tasks are delivered to such downstream components and used to perform (e.g.) logistics operations—for example, package sorting, routing, rejection, etc.

In embodiments, vision system 100 may include a presence-sensing device 166, and may be located at an appropriate position along the flow of objects (e.g., conveyor line) to issue a trigger signal 168. Device 166 may include a photodetector. Processor 140 receives trigger signal 168 to begin image acquisition of target 120. Presence-sensing device 166 may also signal when the object has left an inspection area, and awaits arrival of a new object to begin a new round of image acquisition.

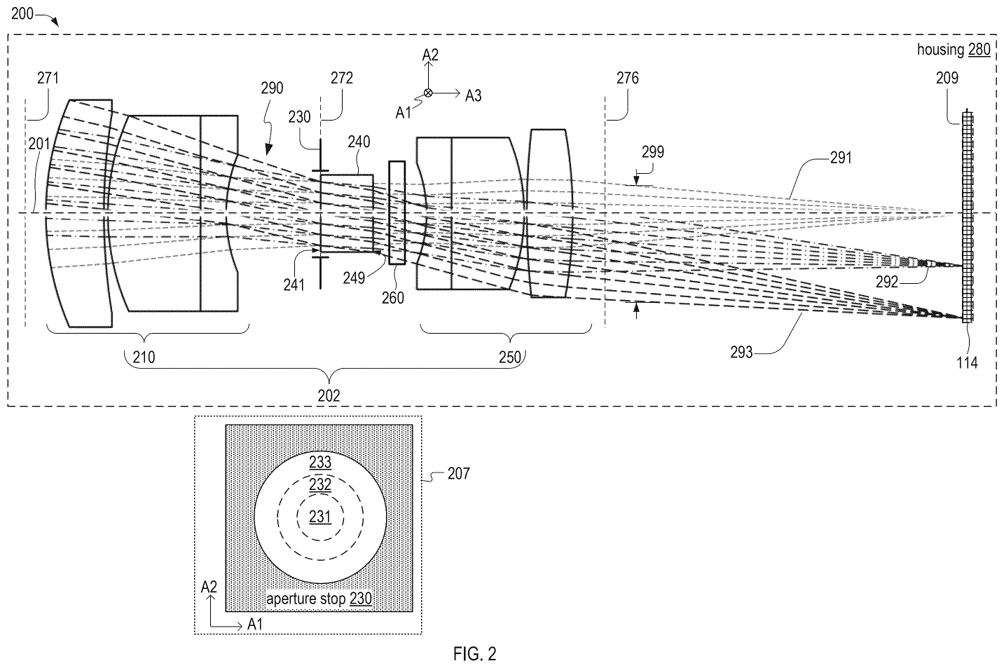

FIG. 2 is a schematic of an example extending working-range imaging system 200, which is an example of imaging system 170 of vision system 100. Figures herein depict orthogonal axes A1, A2, and A3, which are synonymous with axes x, y, and z. Unless otherwise specified, heights and depths of objects herein refer to the object's extent along axis A3. Also, herein, a horizontal plane is parallel to the A1-A2 plane, a width refers to an object's extent along axis A1 or axis A2, and a vertical direction is along axis A3.

Imaging system 200 includes a lens 202, an aperture stop 230, and a phase plate 240. Lens 202 includes at least one of lenses 210 and 250, which may be axially aligned and have common optical axes, denoted as optical axis 201, which is parallel to axis A3. While each of lenses 210 and 250 is illustrated as a compound lens, each including three optical elements, either or both of lenses 210 and 250 may be a single-element lens or a compound lens having a number of optical elements differing from three.

Imaging system 200 may also include a spectral filter 260 along optical axis 201 on either the object side or, as shown in FIG. 2, on the image side of phase plate 240. Phase plate 240 has an object-side surface 241 and an image-side surface 249. Spectral filter 260 may be directly on either of object-side surface 241 or image-side surface 249, e.g., one or more optical coatings.

Imaging system 200 may also include a housing 280 in which each of lens 210, lens 250, and phase plate 240 are attached (either directly or indirectly). Phase plate 240 may be removably attached from housing 280. Aperture stop 230 may also be attached or removably attached to housing 280.

In the example of FIG. 2, both aperture stop 230 and phase plate 240 are between lenses 210 and 250. Phase plate 240 may be located at aperture stop 230, such that part of phase plate 240 is in the plane of aperture stop 230. FIG. 2 includes an inset 207 that illustrates aperture stop 230 in the A1-A2 plane. Aperture stop 230 has an aperture that includes a central region 231, an annular region 232 that surrounds central region 231, and annular region 233 that surrounds both central region 231 and annular region 232.

FIG. 2 denotes planes 271 and 276 that intersect and are perpendicular to optical axis 201. Lens 210 is between plane 271 and lens 250. Lens 250 is between lens 210 and plane 276. Without departing from the scope hereof, (a) one or both of aperture stop 230 and phase plate 240 may be at plane 271, or (b) one or both of aperture stop 230 and phase plate 240 may be at plane 276. Phase plate 240 may adjoin (e.g., be attached to, or be in physical contact with) one of lenses 210 and 250, e.g., when one a surface of lens 210 or lens 250 is at or close to aperture stop 230.

FIG. 2 illustrates imaging system 200 focusing an optical beam 290 at an image plane 209. Imaging system 200 may include image sensor 114 at image plane 209. Optical beam 290 may be represented as a plurality of rays, which includes ray bundles 291, 292, and 293. The propagation of ray bundles 291-293 correspond to when aperture stop 230 is between lenses 210 and 250, as FIG. 2 illustrates. Ray bundles 291-293 have a diameter 299 that varies along optical axis 201. Diameter 299 reaches a minimum at a plane 272 between lens 210 and 250. The position of aperture stop 230 along optical axis 201 may be at plane 272, as shown in FIG. 2. Phase plate 240 may either intersect plane 272 or have a surface that is coplanar with plane 272.

Embodiments of imaging system 200 provide desired image quality for decoding symbols without any specialized software or post-processing. That is phase plate 240 may be used with “off the shelf”/existing imaging devices, without additional changes to the operation of the imaging device. Example imaging devices include the DataMan 280 series and the DataMan 380 series available from Cognex Corporation. Imaging system 200 may be configured based on specific spatial frequencies (e.g., barcode frequencies) to provide the desired image quality for decoding symbols. In embodiments, these spatial frequencies are constant in object space (i.e., as opposed to spatial frequencies that are constant in image space). Imaging system 200 may provide the desired image quality particularly for high contrast, bandwidth-limited objects (e.g., symbols such as barcodes), that have one or more dark zones and light zones, each of which is substantially uniform.

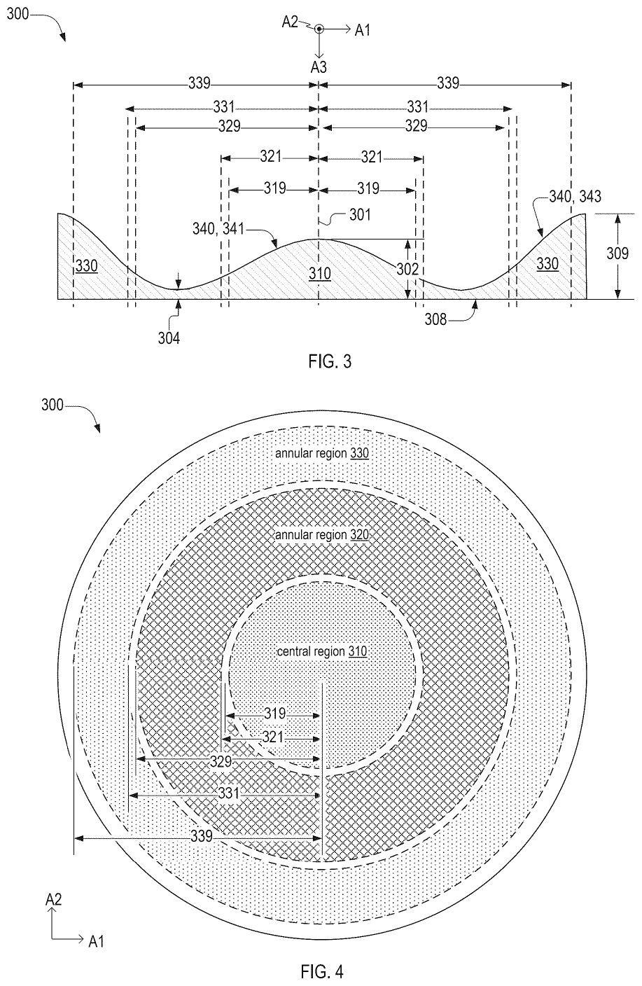

FIG. 3 is a cross-sectional view of a phase plate 300, which is an example of phase plate 240. FIG. 4 is a plan view of phase plate 300. FIGS. 3 and 4 are best viewed together in the following description. Phase plate 300 includes a central region 310 and at least one of an annular region 320 and an annular region 330. Phase plate 300 may be, or include, a monolithic optical element, such that at least two of regions 310, 320, and 330 are respective regions of a monolithic optical element.

Central region 310 has a central phase-transmission function, the magnitude of which is a decreasing function of radial distance from optical axis 301. The radial distance is in a horizontal plane. Annular region 330 surrounds central region 310 and has an outer phase-transmission function, the magnitude of which is an increasing function of radial distance from optical axis 301. In embodiments, the central region has positive optical power, and the annular region has negative optical power.

In embodiments of imaging system 200, phase plate 300 is located at aperture stop 230, and optical axis 201 and optical axis 301 are collinear. In such embodiments, the respective areas occupied by central region 310 and annular region 330 in the plane of aperture stop 230 define central region 231 and an annular region 233 of aperture stop 230.

Phase plate 300 may be axially symmetric about an optical axis 301, as shown in FIG. 4, in which case annular region 330 is a circular annulus. Phase plate 300 may be rotationally symmetric (but not axially symmetric) about optical axis 301, in which case annular region 330 is a polygonal annulus. Central region 310 has a radius 319. Annular region 320 spans between (i) an inner radius 321 that equals or exceeds radius 319 and (ii) an outer radius 329 that exceeds inner radius 321. Annular region 330 spans between (i) an inner radius 331 that equals or exceeds radius 319 and (ii) an outer radius 339 that exceeds inner radius 331. Central region 310 and annular regions 320 and 330 have respective areas that may be substantially equal (e.g., have a relative difference that is less than a predetermined value, such as ten percent). When phase plate 300 includes just one of annular regions 320 and 330, the area of this annular region may be substantially equal to the area of central region 310, e.g., the areas differ by less than ten percent.

The effect of the above-mentioned central and outer phase-transmission functions is to spread the focal range of imaging system 200 lens by changing its focal length for different radial zones in aperture stop 230. Imaging system 200 is therefore at least partially optimized to provide readable contrast only for a specific range of spatial frequencies (e.g., barcode line widths) imaged over a working range before and beyond its focal plane. This differs from a conventional lens, which provides very high contrast over a much wider range of spatial frequencies in a very narrow distance range. Image system 200 has high contrast over a relatively narrower range of frequencies, but also over a much longer distance range. Hence, the inclusion of phase plate 300 in imaging system 200 trades peak resolution for broader depth performance over only spatial frequencies of interest—for example 10-13 mil barcodes (3 to 4 lines per millimeter). Accordingly, embodiments disclosed herein increase the working range of an imaging system without either post-processing images or the costs associated with stopping down and without image processing.

Phase plate 300 has an on-axis thickness 302, a minimum thickness 304, and a maximum thickness 309. In embodiments, phase plate 300 is a graded-index optical component having an axially symmetric refractive index n(r), where r=\sqrt{x²+y²}. In such embodiments, phase plate 300 may have a planar front surface and planar back surface, each of which is orthogonal to optical axis 301. In such embodiments, phase plate 300 has a uniform thickness, and thicknesses 302, 304, and 309 are equal.

Herein, a phase-transmission function of an optical element is the phase (or argument) of the optical element's complex amplitude transmittance, as known in the art. The complex amplitude transmittance of phase plate 300 may be expressed as t(x,y) defined in equation (1).

$$t ( x , y ) = U ( x , y , d ) / U ( x , y , 0 ) \qquad ( 1 )$$

In equation (1), U(x,y,0) is the complex amplitude of a wave incident on phase plate 300 and U(x,y,d) is the complex amplitude of a wave incident on phase plate 300, where d is the thickness of phase plate 300.

In the following description, phase plate 300 has a refractive index n and a thickness d, each of which may be spatially varying in the x-y plane. Accordingly, the refractive index and thickness may be expressed as n(x,y) and d(x,y) respectively. Refractive index n(x,y) may be spatially uniform or spatially non-uniform. When both a maximum thickness dₘₐₓ of phase plate 300 and the incident angle θ of light at wavelength λ₀ incident on phase plate 300 are sufficiently small, the phase transmission function of phase plate 300 may be expressed by t(x,y) in equation (2).

$$t ( x , y ) = exp [ - jn ( x , y ) {k}_{0} d ( x , y ) ] \qquad ( 2 )$$

For example, equation (2) may be applicable when (dₘₐₓ/λ₀)θ²/2n<<1. The phase-transmission function is then arg (t(x,y))=−n(x,y)k₀d(x,y), hereinafter equation (3). The magnitude of the phase-transmission function is |arg(t(x,y))|=|n(x,y)k₀d(x,y)|, hereinafter equation (4). Since the value of refractive index n(x,y) depends on an operating wavelength λ₀ of phase plate 300, the value of the phase-transmission function also depends on the operating wavelength. This operating wavelength may be in the visible or near-IR regions or the electromagnetic spectrum.

At operating wavelength λ₀, the respective magnitudes of phase plate 300's central and outer phase-transmission functions are decreasing and increasing, respectively. To reduce or minimize the effects of a spatially uniform phase delay imparted by phase plate 300 within imaging system 200, it is advantageous for phase plate 300 to be thin compared to the operating wavelength. For example, when phase plate 300 has a uniform refractive index n, on-axis thickness 302 may differ from minimum thickness 304 by less than λ₀/2n. More generally, within central region 310 and annular region 330, a difference between the maximum optical thickness and the minimum optical thickness is less than λ₀/2, where the optical thickness of phase plate 300 at a position (x,y) of the product of its physical thickness d(x,y) and its refractive index n(x,y).

Phase plate 300 has a surface 340 and a surface 308 opposite surface 340. Surface 308 is planar in the embodiment illustrated in FIG. 3, surface 308 may be nonplanar without departing from the scope hereof. For example, part of surface 308 within central region 310 may be convex or concave.

Surface 340 includes a central surface-region 341 and an outer surface-region 343, which are part of central region 310 and annular region 330, respectively. Central region 310 may be a positive axicon. In such embodiments, central region 310 is axially symmetric about optical axis 301, and central surface-region 341 is linear or substantially linear in a cross-sectional half-plane that intersects optical axis 301.

That is, surface 340 may satisfy a sag equation z(r), as shown in equation (3), where r=\sqrt{x²+y²}.

$$z ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + {a}_{7} {r}^{7} + {a}_{8} {r}^{8} + … \qquad ( 3 )$$

In embodiments, surface 340 is an odd-aspheric surface where, for example, at least one of the even coefficients (a₂, a₄, a₆, a₈, . . . ) equals zero and at least one of the odd coefficients (a₁, a₃, a₅, a₇, . . . ) is non-zero. When surface 340 is an odd aspheric surface, central region 310 may be a positive axicon. In other embodiments, surface 340 is an even-aspheric surface where, for example, at least one of the even coefficients (a₂, a₄, a₆, a₈, . . . ) is non-zero and at least one of the odd coefficients (a₁, a₃, a₅, a₇, . . . ) equals zero.

An example of a linear surface region is one in which coefficient a₁ is non-zero, and all other coefficients a_{k≠1} equal zero. An example of “substantially linear” surface is a surface with a surface sag having peak-to-valley deviation from a linear surface (e.g., a_{k≠1}=0) by less than a threshold value. This threshold value may be a multiple or a fraction of the operating wavelength λ₀, such as λ₀, λ₀/2, λ₀/4, or λ₀/10.

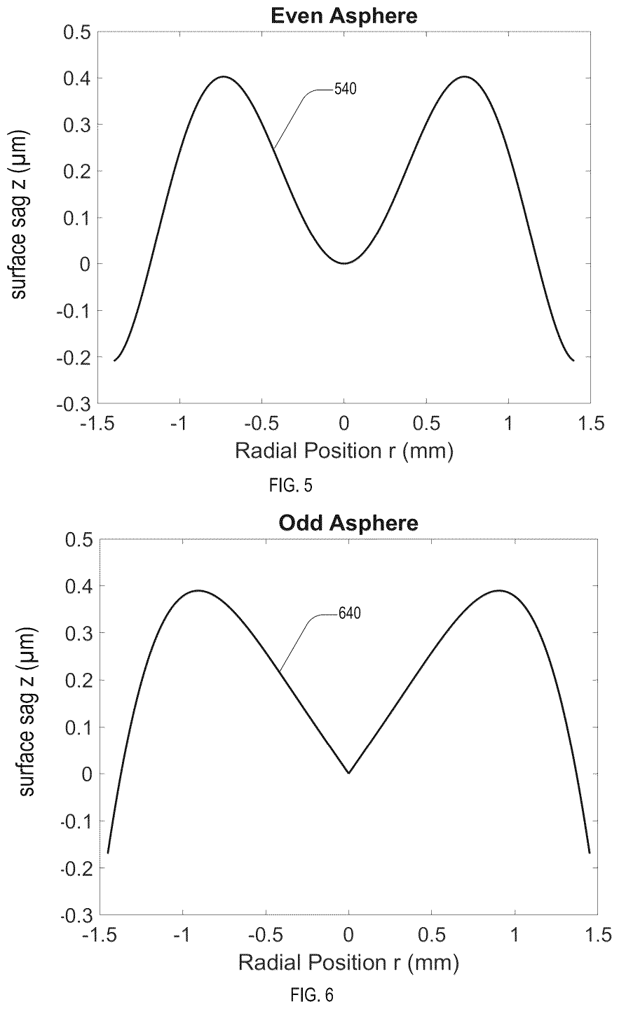

FIG. 5 is a graph of an even-aspheric surface sag 540, which satisfies equation (3) where each odd aspheric coefficient equals zero. In embodiments, surface 340 has surface sag 540. Surface sag 540 has the following non-zero coefficients: a₂=1.7087×10⁻³ a₄=−2.1997×10⁻³, a₆=8.1452× 10⁻⁴, and a₈=−8.4060×10⁻⁵.

FIG. 6 is a graph of an odd-aspheric surface sag 640, which satisfies equation (3) where each even aspheric coefficient equals zero. In embodiments, surface 340 has surface sag 640. Surface sag 640 has the following non-zero coefficients: a₁=5.1005×10⁻⁴ a₃=9.1952× 10⁻⁵, a₅=−2.5956×10⁻⁴, and a₇=3.5150×10⁻⁵.

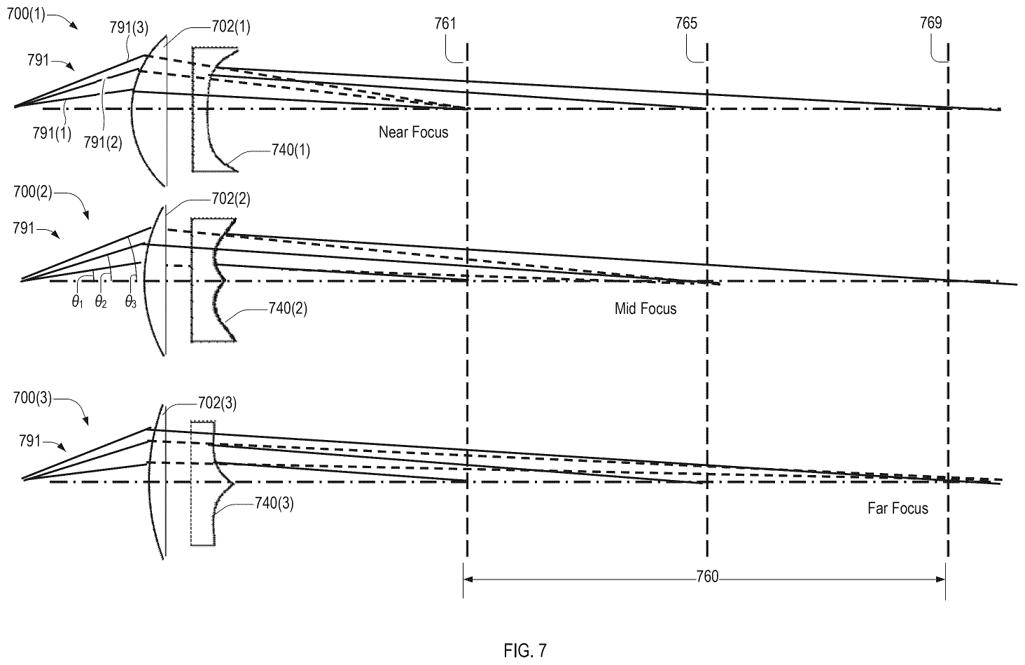

FIG. 7 is a schematic of imaging systems 700(1), 700(2), and 700(3), which are examples of imaging system 200. Each imaging system 700 includes a lens 702 and a phase plate 740, which are respective examples of lens 202 and phase plate 240, FIG. 2. As an example of lens 202, each lens 702 may include one or both of lenses 210 and 250 introduced in the description of imaging system 200. FIG. 7 depicts a working range 760 of imaging system 700 and planes 761, 765, and 769, which are at the near limit of working range 760, a middle location within working range 760, and a far limit of working range 760, respectively.

In each of imaging systems 700, rays 791 are incident on lens 702. When imaging system 700 does not include phase plate 740, lenses 702(1), 702(2), and 702(3) image rays 791 to planes 761, 765, and 769, respectively, as shown by the dashed rays that exit each lens 702. Phase plate 740 causes each imaging system 700 to have a focal length that depends on the propagation angle of ray 791. Rays 791 include rays 791(1-3), which propagate toward lens 702 at respective incident angles θ₁, θ₂, and θ₃, with respect to the optical axis of imaging system 700, where θ₁<θ₂<θ₃. The presence of phase plate 740 in imaging system 700 results in rays 791(1-3) being imaged to planes 761, 765, and 769, respectively.

Each phase plate 740 has a phase-transmission function (equation (3)) that may have a different slope in each of regions 310, 320, and 330 introduced in the description of phase plate 300. Table 1 indicates whether the phase-transmission function is a constant function, an increasing function, or a decreasing function as a function of increasing radial distance from optical axis within each of regions 310, 320, and 330. For example, the phase-transmission function is phase plate 740(1) is constant (flat) in central region 310 (not on the optical axis, i.e., r≠0), and an increasing function in both of annular regions 320 and 330. In embodiments, phase plate 740 includes one or both of annular regions 320 and 330.

TABLE 1
Magnitude of phase-transmission function as a
function of radial distance from optical axis

| phase transmission | central | annular | annular |
|---|---|---|---|
| function | region 310 | region 320 | region 330 |
| phase plate 740(1) | constant | increasing | increasing |
| phase plate 740(2) | decreasing | constant | increasing |
| phase plate 740(3) | decreasing | decreasing | constant |

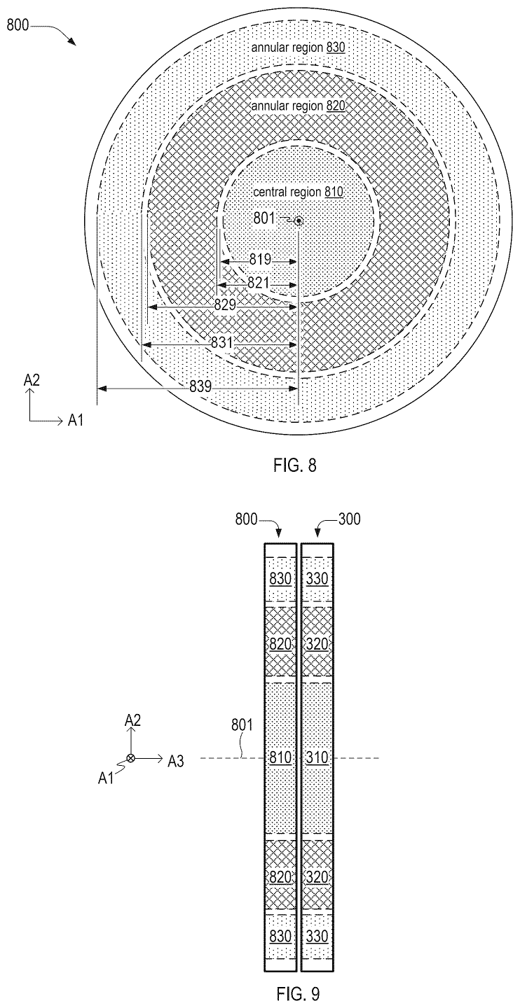

FIG. 8 is a plan view of spectral filter 800, which is an example of spectral filter 260 of imaging system 200, FIG. 2. Spectral filter 800 includes at least one of a central region 810, an annular region 820, and an annular region 830. Spectral filter 800 may include additional annular regions. Spectral filter 800 may be, or include, a monolithic optical element, such that at least two of regions 810, 820, and 830 are respective regions of a monolithic optical element. In imaging system 200, regions 810, 820, and 830 may be aligned to regions 231, 232, and 233, respectively.

Spectral filter 800 is an example of spectral filter 260 of imaging system 200, in which aperture stop 230 has regions 231, 232, and 233. In embodiments, regions 810, 820, and 830 filter respective parts of optical beam 290 that traverse respective regions 231, 232, and 233 of aperture stop 230. Similarly, in embodiments, regions 810, 820, and 830 filter respective parts of optical beam 290 that traverse respective regions 310, 320, and 330 of phase plate 300. For example, FIG. 9 is a side view of phase plate 300 and spectral filter 800, where regions 810, 820, and 830 are aligned to respective regions 310, 320, and 330. When spectral filter 800 is an optical coating, regions 810, 820, and 830 may be directly on respective regions 310, 320, and 330 of phase plate 300.

Each of regions 810, 820, and 830 may have a respective passband. In embodiments, each of regions 810, 820, and 830 has a respective one of three passbands, which may correspond to spectral bands 181, 182, and 183 introduced in FIG. 1. Table 2 shows passbands of regions 810, 820, and 830 in embodiments A-F of spectral filter 800.

TABLE 2
Spectral passbands of regions 810,
820, and 830 of spectral filter 800

| embodiment | A | B | C | D | E | F |
|---|---|---|---|---|---|---|
| region 810 | blue | red | green | green | blue | red |
| region 820 | green | green | blue | red | red | blue |
| region 830 | red | blue | red | blue | green | green |

In embodiments, imaging system 200 includes spectral filter 800 as spectral filter 260, and light source 130 can selectively change the optical spectrum of illumination 180 to include one or more of spectral bands 181-183. In such embodiments, imaging device 110 can change the focal length of imaging system 200 by changing the optical spectrum of illumination 180. For example, in phase plate 300, annular regions 310, 320, and 330 may be associated with respective focal lengths f₁, f₂, and f₃, as illustrated, for example, by imaging system 700(1-3) of FIG. 7. In each of imaging systems 700, f₁<f₂<f₃. The relative magnitudes of focal lengths f₁, f₂, and f₃ may differ without departing from the scope hereof.

In embodiment A of Table 2, regions 810, 820, and 830 are aligned to respective regions 310, 320, and 330 of phase plate 300. In this embodiment, the focal length of imaging system 200 is f₁ when illumination 180 is blue, f₂ when illumination 180 is green, and f₃ when illumination 180 is red.

Spectral filter 800 may be axially symmetric, e.g., about an optical axis 801, in which case annular region 830 is a circular annulus. Spectral filter 800 may be rotationally symmetric (but not axially symmetric) about optical axis 301, in which case annular region 830 is a polygonal annulus.

FIG. 8 denotes radii 819, 821, 829, 831, and 839. Central region 810 has radius 819. Annular region 820 spans between (i) inner radius 821 that equals or exceeds radius 819 and (ii) outer radius 829 that exceeds inner radius 821. Annular region 830 spans between (i) an inner radius 831 that equals or exceeds radius 819 and (ii) an outer radius 839 that exceeds inner radius 831. Central region 810 and annular regions 820 and 830 have respective areas that may be substantially equal (e.g., have a relative difference that is less than a predetermined value, such as ten percent).

In embodiments, radii 819, 821, 829, 831, and 839 are analogous to radii 319, 321, 329, 331, and 339 introduced in the description of phase plate 300. That is, at least one of the following radii may be equal: radii 319 and 819, radii 321 and 821, radii 329 and 829, radii 331 and 831, and radii 339 and 839.

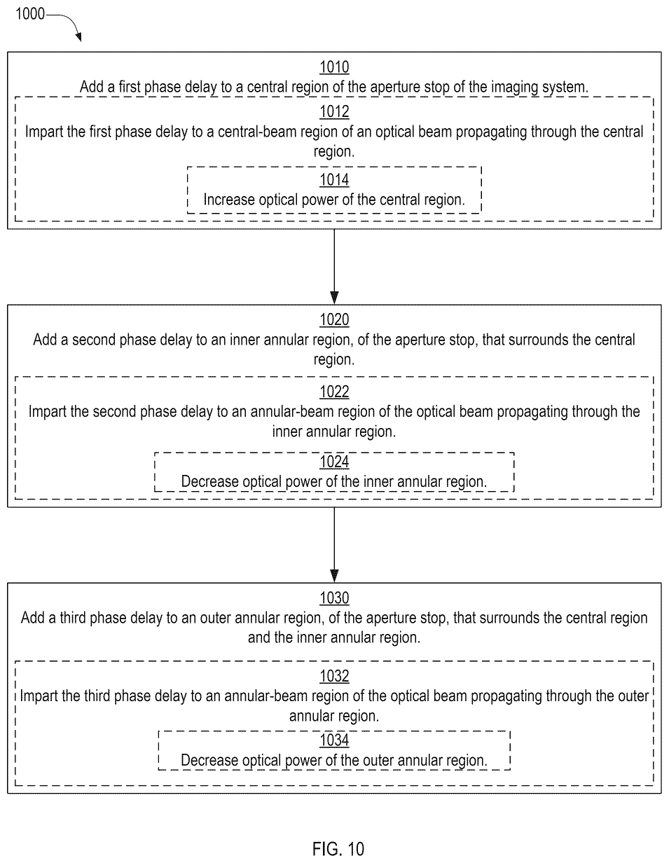

FIG. 10 is a flowchart illustrating a method 1000 for extending a working range of an imaging system. Method 1000 includes at least one of steps 1010, 1020, and 1030. The following description of method 1000 includes parenthetical numbers following terms used in a method step. The parenthetical number indicates that the element associated with the number in parentheses is an example of the term. For example, the description of step 1010 below recites “a central region (231) of the aperture stop (230) of the imaging system (200).” This means that aperture stop 230, central region 231, and imaging system 200 are respective examples of the aperture stop, the central region of the aperture stop, and the imaging system of method 1000.

Step 1010 includes adding a first phase delay to a central region (231) of the aperture stop (230) of the imaging system (200). A magnitude of the first phase delay is a first function of radial distance from an optical axis of the imaging system. The magnitude of the first phased delay may be expressed by equation (4). The first function may be a constant function, an increasing function, or a decreasing function.

Step 1010 may include step 1012, which includes imparting the first phase delay to a central-beam region of an optical beam (290) propagating through the central region. Step 1012 may include a step 1014, which includes increasing optical power of the central region.

Step 1020 includes adding a second phase delay to an annular region (232), of the aperture stop, that surrounds the central region. A magnitude of the second phase delay is a second function of radial distance from the optical axis. The magnitude of the second phased delay may be expressed by equation (4). The second function may be a constant function, an increasing function, or a decreasing function.

Step 1020 may include step 1022, which includes imparting the second phase delay to an annular-beam region of the optical beam (290) propagating through the inner annular region. Step 1022 may include step 1024, which includes imparting decreasing optical power of the inner annular region.

Step 1030 includes adding a third phase delay to an outer annular region (233), of the aperture stop, that surrounds the central region and the inner annular region. A magnitude of the third phase delay is a third function of radial distance from the optical axis. The third function may be a constant function, an increasing function, or a decreasing function.

Step 1030 may include step 1032, which includes imparting the third phase delay to an additional annular-beam region of the optical beam (290) propagating through the outer annular region. Step 1032 may include step 1034, which includes imparting decreasing optical power of the outer annular region.

### Combinations of Features

Features described above, as well as those claimed below, may be combined in various ways without departing from the scope hereof. The following enumerated examples illustrate some possible, non-limiting combinations.

Embodiment 1, A method for extending a working range of an imaging system, wherein the imaging system has an optical axis and an aperture stop. The method includes at least one of: (i) adding a first phase delay to a central region of the aperture stop; (ii) adding a second phase delay to an inner annular region, of the aperture stop, that surrounds the central region; or (iii) adding a third phase delay to an outer annular region, of the aperture stop, that surrounds the central region and the inner annular region. Magnitudes of the first, the second, and the third phase delay are, respectively a first function, a second function, and a third function of radial distance from the optical axis.

Embodiment 2. The method of embodiment 1, wherein at least one of: adding the first phase delay includes imparting the first phase delay to a central-beam region of an optical beam propagating through the central region; adding the second phase delay includes imparting the second phase delay to an annular-beam region of the optical beam propagating through the inner annular region; or adding the third phase delay includes imparting the third phase delay to an additional annular-beam region of the optical beam propagating through the outer annular region.

Embodiment 3. The method of either one of embodiments 1 and 2, wherein: imparting the first phase delay includes increasing optical power of the central region; and at least one of (i) imparting the second phase delay includes imparting decreasing optical power of the inner annular region and (ii) imparting the third phase delay includes imparting decreasing optical power of the outer annular region.

Embodiment 4. A working-range-extending phase plate includes a central region, an inner annular region surrounding the central region, and an outer annular region surrounding the central region and the inner annular region. The central region has a central phase-transmission function. The inner annular region has an inner phase-transmission function. The outer annular region has an outer phase-transmission function. Respective magnitudes of the central, the inner, and the outer phase-transmission functions are, as a function of radial distance from an optical axis of the phase plate, one of: (i) constant, increasing, and increasing, (ii) decreasing, constant, and increasing, or (iii) decreasing, decreasing, and constant.

Embodiment 5. The phase plate of embodiment 4, wherein the central region is axially symmetric about the optical axis, and the phase plate further comprises: a surface that includes a central surface-region and an outer surface-region, which are part of the central region and the outer annular region, respectively; wherein the central surface-region is substantially linear in a cross-sectional half-plane that intersects the optical axis, such that the central region is substantially a positive axicon.

Embodiment 6. The phase plate of either one of embodiments 4 or 5, further including an odd-aspheric surface that includes a central surface-region and an outer surface-region, which are part of the central region and the outer annular region, respectively.

Embodiment 7. The phase plate of any one of embodiments 4-6, further including an even-aspheric surface that includes a central surface-region and an outer surface-region, which are part of the central region and the outer annular region, respectively.

Embodiment 8. The phase plate of any one of embodiments 4-7, wherein the central region has a positive optical power and the outer annular region has negative optical power.

Embodiment 9. The phase plate of any one of embodiments 4-8, wherein: the magnitudes of the central and the outer phase-transmission functions are, as a function of radial distance from an optical axis of the phase plate, respectively decreasing and increasing at an operating wavelength of the phase plate, and a maximum optical thickness within the central region and the outer annular region differs from a minimum optical thickness within the central region and outer annular region by less than one-half the operating wavelength.

Embodiment 10. The phase plate of any one of embodiments 4-9, wherein the central region and the outer annular region each have a same spatially uniform refractive index, and a maximum physical thickness of the central region differs from a minimum physical thickness of the outer annular region by less than one-half the operating wavelength.

Embodiment 11. The phase plate of any one of embodiments 4-10, wherein each of the central region, the inner annular region, and the outer annular region are axially symmetric about the optical axis and have a refractive index that varies radially as a function of distance from the optical axis.

Embodiment 12. The phase plate of any one of embodiments 4-11, wherein the central region, the inner annular region, and the outer annular region occupy respective areas of the phase plate that are substantially equal.

Embodiment 13. The phase plate of any one of embodiments 4-12, wherein the respective magnitudes of the central, the inner, and the outer phase-transmission functions are, as a function of radial distance from the optical axis of the phase plate: constant, increasing, and increasing.

Embodiment 14. The phase plate of any one of embodiments 4-13, wherein the respective magnitudes of the central, the inner, and the outer phase-transmission functions are, as a function of radial distance from the optical axis of the phase plate: decreasing, constant, and increasing.

Embodiment 15. The phase plate of any one of embodiments 4-14, wherein the respective magnitudes of the central, the inner, and the outer phase-transmission functions are, as a function of radial distance from the optical axis of the phase plate: decreasing, decreasing, and constant.

Embodiment 16. An extended working-range imaging system includes: a first lens; a second lens axially aligned with the first lens; and a phase plate of located at an aperture stop of the extended working-range imaging system.

Embodiment 17. The imaging system of embodiment 16, wherein the aperture stop and the phase plate are between the first lens and the second lens.

Embodiment 18. The imaging system of either one of embodiments 16 and 17, wherein the first lens is between the phase plate and the second lens.

Embodiment 19. The imaging system of any one of embodiments 16-18, wherein the second lens is between the first lens and the phase plate.

Embodiment 20. The imaging system of any one of embodiments 16-19, further including: a housing in which (i) each of the first lens and the second lens are attached and (ii) the phase plate is removably attached.

Embodiment 21. The imaging system of any one of embodiments 16-20, further includes a spectral filter. The spectral filter includes at lease one of: a central filter-region, an inner annular filter-region, and/or an outer annular filter-region. The central filter-region is aligned to the central region of the phase plate and having a first spectral passband. The inner annular filter-region is aligned to the inner annular region of the phase plate and having a second spectral passband. The outer annular filter-region is aligned to the outer annular region of the phase plate and having a third spectral passband. Each of the first, the second, and the third spectral passbands corresponds to a respective one of the blue, the green, and the red spectral bands of the electromagnetic spectrum.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C,” “at least one of A, B, and C,” and “at least one of A, B, or C,” such phrasing encompasses the selection of (i) A only, or (ii) B only, or (iii) C only, or (iv) A and B only, or (v) A and C only, or (vi) Band C only, or (vii) each of A and B and C. This may be extended for as many items as are listed.

As used herein, a symbol can refer to any optical, machine-readable representation of data. “Code” can refer to the actual data represented by the symbol. Examples of a Code can include a part number, serial number, tracking identifier, transaction code, or other data type. “Symbol” can refer to text, an arrangement of parallel bars and spaces that encode the data, e.g., 1D barcodes, or to the arrangement of black and white cells in a designated order in a grid, e.g., 2D matrix codes.

One-dimensional (1D) symbols can include a single row of bars and spaces. The code can be encoded by varying the width and spacing of parallel lines (width modulation), e.g., Code39, Code 128, Interleaves 2 of 5, UPC-A, UPC-E, EAN 8&13, EAN-128, Codebar, Code 93, RSS14, RSS Limited, RSS Stacked, etc. The symbol can also have varied height bars (height modulation).

2-D stacked barcodes (1.5D), can include multiple rows of width-modulated bars and spaces. Each row can have the same physical length and resemble a 1D linear symbol. Two-dimensional (2D) barcodes, which can include rectangles, dots, hexagons, and other geometric patterns, called matrix codes, can contain much more information than 1D or 1.5D barcodes. Examples can include MaxiCode, Data Matrix, Aztec Code, QR Code, Vericode, Array Tag, Dotcode, LEB-code, MiniCode, and GridMatrix Code.

In addition to barcode symbology, symbols can also take the form of printed or hand-written alphanumeric text (e.g., via a label). Symbols may also refer to patterns used with pattern recognition and/or feature recognition. As a specific example, symbols may include address labels or product-identification labels. Generally, symbols are not limited to any of the examples explicitly discussed but include any type of indication attached to or associated with an object that provides information about the object.

The following claims are intended to cover all generic and specific features described herein, as well as all statements of the scope of the present method and system, which, as a matter of language, might be said to fall therebetween.

We claim:

1. A method for extending a working range of an imaging system having an optical axis and an aperture stop, comprising at least one of:
adding a first phase delay to a central region of the aperture stop, a magnitude of the first phase delay being a first function of radial distance from the optical axis;
adding a second phase delay to an inner annular region, of the aperture stop, that surrounds the central region, a magnitude of the second phase delay being a second function of radial distance from the optical axis; or
adding a third phase delay to an outer annular region, of the aperture stop, that surrounds the central region and the inner annular region, a magnitude of the third phase delay being a third function of radial distance from the optical axis,
wherein one of (i) the first function is a constant function, and each of the second function and the third function is a decreasing function, (ii) the first function is an increasing function, the second function is a constant function, and the third function is a decreasing function, or (iii) each of the first function and the second function is an increasing function and the third function is a constant function.

2. The method of claim 1, wherein at least one of:
adding the first phase delay includes imparting the first phase delay to a central-beam region of an optical beam propagating through the central region;
adding the second phase delay includes imparting the second phase delay to an annular-beam region of the optical beam propagating through the inner annular region; or
adding the third phase delay includes imparting the third phase delay to an additional annular-beam region of the optical beam propagating through the outer annular region.

3. The method of claim 2, wherein:
imparting the first phase delay includes increasing optical power of the central region; and
at least one of (i) imparting the second phase delay includes imparting decreasing optical power of the inner annular region and (ii) imparting the third phase delay includes imparting decreasing optical power of the outer annular region.

4. A working-range-extending phase plate comprising:
a central region having a central phase-transmission function;
an inner annular region surrounding the central region and having an inner phase-transmission function; and
an outer annular region surrounding the central region and the inner annular region and having an outer phase-transmission function, wherein respective magnitudes of the central, the inner, and the outer phase-transmission functions are, as a function of radial distance from an optical axis of the phase plate, one of:
(i) constant, increasing, and increasing;
(ii) decreasing, constant, and increasing; or
(iii) decreasing, decreasing, and constant.

5. The phase plate of claim 4, wherein the central region is axially symmetric about the optical axis, and the phase plate further comprises:
a surface that includes a central surface-region and an outer surface-region, which are part of the central region and the outer annular region, respectively;
wherein the central surface-region is substantially linear in a cross-sectional half-plane that intersects the optical axis, such that the central region is substantially a positive axicon.

6. The phase plate of claim 4, further comprising an odd-aspheric surface that includes a central surface-region and an outer surface-region, which are part of the central region and the outer annular region, respectively.

7. The phase plate of claim 4, further comprising an even-aspheric surface that includes a central surface-region and an outer surface-region, which are part of the central region and the outer annular region, respectively.

8. The phase plate of claim 4, wherein the central region has a positive optical power and the outer annular region has negative optical power.

9. The phase plate of claim 4, wherein:
the magnitudes of the central and the outer phase-transmission functions are, as a function of radial distance from an optical axis of the phase plate, respectively decreasing and increasing at an operating wavelength of the phase plate, and
a maximum optical thickness within the central region and the outer annular region differs from a minimum optical thickness within the central region and outer annular region by less than one-half the operating wavelength.

10. The phase plate of claim 9, wherein:
the central region and the outer annular region each have a same spatially uniform refractive index; and
a maximum physical thickness of the central region differs from a minimum physical thickness of the outer annular region by less than one-half the operating wavelength.

11. The phase plate of claim 4, wherein each of the central region, the inner annular region, and the outer annular region are axially symmetric about the optical axis and have a refractive index that varies radially as a function of distance from the optical axis.

12. The phase plate of claim 4, wherein the central region, the inner annular region, and the outer annular region occupy respective areas of the phase plate that are substantially equal.

13. The phase plate of claim 4, wherein the respective magnitudes of the central, the inner, and the outer phase-transmission functions are, as a function of radial distance from the optical axis of the phase plate: constant, increasing, and increasing.

14. The phase plate of claim 4, wherein the respective magnitudes of the central, the inner, and the outer phase-transmission functions are, as a function of radial distance from the optical axis of the phase plate: decreasing, constant, and increasing.

15. The phase plate of claim 4, wherein the respective magnitudes of the central, the inner, and the outer phase-transmission functions are, as a function of radial distance from the optical axis of the phase plate: decreasing, decreasing, and constant.

16. An extended working-range imaging system comprising:
a first lens;
a second lens axially aligned with the first lens; and
a phase plate of claim 4 located at an aperture stop of the extended working-range imaging system.

17. The imaging system of claim 16, wherein the aperture stop and the phase plate are between the first lens and the second lens.

18. The imaging system of claim 16, wherein the first lens is between the phase plate and the second lens and/or the second lens is between the first lens and the phase plate.

19. The imaging system of claim 16, further comprising:
a housing in which (i) each of the first lens and the second lens are attached and (ii) the phase plate is removably attached.

20. The imaging system of claim 16, further comprising a spectral filter that includes:
a central filter-region aligned to the central region of the phase plate and having a first spectral passband; and/or
an inner annular filter-region aligned to the inner annular region of the phase plate and having a second spectral passband; and/or
an outer annular filter-region aligned to the outer annular region of the phase plate and having a third spectral passband,
wherein each of the first, the second, and the third spectral passbands corresponds to a respective one of the blue, the green, and the red spectral bands of the electromagnetic spectrum.
